(19) United States
(12) Patent Application Publication
(10) Pub. No.: US 2025/0076466 A1
(43) Pub. Date: Mar. 6, 2025

(54) SENSOR ASSEMBLY AND A DEVICE COMPRISING THE SENSOR ASSEMBLY

(71) Applicant: Shanghai Kohler Electronics, Ltd., Shanghai (CN)

(72) Inventor: Xiaojun Zhou, Shanghai (CN)

(21) Appl. No.: 18/818,215

(22) Filed: Aug. 28, 2024

(30) Foreign Application Priority Data
Sep. 1, 2023 (CN) 202322388439.3

(51) Int. Cl. G01S 7/481

(52) U.S. Cl. CPC G01S 7/4813

(57) ABSTRACT

A sensor assembly includes: a sensor; a housing comprising a detecting wall configured to cover the sensor; and a light-shielding part. The light-shielding part includes a first light-shielding rib having a first end disposed on an inner surface of the detecting wall and a second end extending into an inside of the detecting wall; and a second light-shielding rib having a first end disposed on an outer surface of the detecting wall and a second end extending into the inside of the detecting wall. The first light-shielding rib and the second light-shielding rib are at least partially overlapped along a thickness direction of the detecting wall.

### CROSS REFERENCE TO RELATED APPLICATION

This application claims the benefit of priority to: Chinese Patent Application No. 202322388439.3 filed in the Chinese Intellectual Property Office on Sep. 1, 2023, which is hereby incorporated by reference in its entirety.

### FIELD

The present disclosure relates to the technical field of a sensor and particularly relates to a sensor assembly and a device comprising the sensor assembly.

### BACKGROUND

A distance sensor uses an emitter to emit an infrared light or a laser. After hitting an obstacle, the emitted light is reflected to the sensor. The distance sensor measures the distance between the obstacle and the sensor based on the time difference between the time when the light is emitted and the time when the light reflected. When the sensor is applied to industrial products such as sanitary products, an effect of a sensing control without touching can be achieved, cross-infection can be effectively avoided, and the water resource can be saved.

At present, a Time of Flight (TOF) sensor is a common distance sensor. A device with a light-permeable housing is provided outside the TOF sensor to ensure that the TOF sensor may normally emit and receive light. However, the light-permeable housing has the problem related to the internal reflection, which affects the normal operation of the TOF sensor. Generally, a shielding rib running through the housing is provided within the housing to solve the problem related to the internal reflection. However, water and dust are prone to leak at the position of the connection between the shielding rib and the housing. This affects the detecting accuracy of the TOF sensor and even causes failures of the TOF sensor.

### SUMMARY

The objective of the present disclosure is to provide a sensor assembly and a device including the sensor assembly. The present disclosure may solve the problem that lights interfere with each other, which is caused by the internal reflection of the housing. The present disclosure may also solve the problem that water and dust leak into the sensor, which is caused by the detecting wall being passed through. This may ensure the accurate and reliable operation of the sensor.

The present disclosure provides a sensor assembly including: a sensor, a housing covered an outer side of the sensor, and a light-shielding part provided on the housing. The sensor includes an emitting end and a receiving end. The housing includes a detecting wall including a light permeable emitting area and a receiving area. The emitting area faces the emitting end such that the emitting end emits detecting light toward an outer side of the housing. The receiving area faces the receiving area such that the receiving end receives the reflected light. The light-shielding part is located between the emitting area and the receiving area and includes a first light-shielding rib and a second light-shielding rib. A first end of the first light-shielding rib is located on an inner surface of the detecting wall. A second end of the first light-shielding rib extends into the detecting wall. A first end of the second light-shielding rib is located on an outer surface of the detecting wall. A second end of the second light-shielding rib extends into the detecting wall. The first light-shielding rib and the second light-shielding rib are at least partially overlapped along a thickness direction of the detecting wall.

In an embodiment, the light-shielding part further includes a third light-shielding rib having an effect of light-shielding. A first end of the third light-shielding rib is located on an inner surface of the detecting wall. A second end of the third light-shielding rib extends into the detecting wall. The second light-shielding rib is located between the first light-shielding rib and the third light-shielding rib.

In an embodiment, both the first light-shielding rib and the third light-shielding rib are provided obliquely toward the second light-shielding rib.

In an embodiment, at least one of the first light-shielding rib, the second light-shielding rib, or the third light-shielding rib tapers in the thickness along a direction toward an interior of the detecting wall.

In an embodiment, the sensor assembly further includes a circuit board, and the sensor is mounted on the circuit board.

In an embodiment, the sensor assembly further includes a sealing spacer, which is hermetically provided between the circuit board and an inner surface of the housing.

In an embodiment, the sensor assembly further includes a solenoid valve, and the circuit board is communicably coupled to the solenoid valve.

In an embodiment, the sensor assembly further includes a bracket, which is mounted on the housing. The bracket includes an abutting part, which abuts against a side of the circuit board away from the sealing spacer.

In an embodiment, the light-shielding part is formed integrally with the detecting wall.

The present disclosure provides a device including a sensor assembly as described in any of embodiments as described above.

By adopting the above technical solutions, the following beneficial effects can be obtained.

The sensor assembly and the device including the sensor assembly provided in the present disclosure make the light paths between the emitting area and the receiving area be independent from and not interfere with each other by providing a light-shielding part between a light permeable emitting area and a receiving area. A first light-shielding rib and a second light-shielding rib on the light-shielding part extend from an inner surface and an outer surface of the detecting wall respectively to an internal of the detecting wall and are at least partially overlapped in the thickness direction of the detecting wall. The present disclosure may solve the problem that lights interfere with each other, which is caused by the internal reflection of the housing. The present disclosure may also solve the problem that water and dust leak into the sensor, which is caused by the detecting wall being passed through. An effect of waterproof, moisture-proof, and dust-proof may be realized, and the accurate and reliable operation of the sensor may be ensured.

### BRIEF DESCRIPTION OF THE FIGURES

FIG. 1 is a longitudinal sectional view of a sensor assembly in an embodiment of the present disclosure;

FIG. 2 is a structural schematic view of a sensor assembly in an embodiment of the present disclosure, illustrating a reflecting angle and an emitting angle;

FIG. 3 is an exploded view of a sensor assembly in an embodiment of the present disclosure;

FIG. 4 is a block diagram of a circuit board according to an embodiment of the present disclosure;

FIG. 5 is a block diagram of a device comprising a sensor assembly according to an embodiment of the present disclosure; and

FIG. 6 is a flow chart of a method for manufacturing a sensor assembly according to an embodiment of the present disclosure.

### REFERENCE NUMERALS

1—sensor;
2—housing, 20—detecting wall, 21—inner surface, 22—outer surface, 23—emitting area, 24—receiving area;
3—light-shielding part, 30—first light-shielding rib, 31—second light-shielding rib, 32—third light-shielding rib;
4—circuit board;
5—sealing spacer;
6—solenoid valve, 60—wires;
7—power supply, 70—power wire;
8—bracket, 80—abutting part; and
9—code label.

### DETAILED DESCRIPTION

Hereinafter, the specific embodiments of the present disclosure are further described by reference to the drawings.

It is readily understood that, according to the technical solutions of the present disclosure, a plurality of structures as well as implementations are interchangeable by those having ordinary skill in the art without varying the substantial spirit of the present disclosure. Therefore, the following specific embodiments as well as the accompanying drawings are merely illustrations of the technical solutions of the present disclosure and should not be regarded as the entirety of the present disclosure or be regarded as a limitation or a restriction to the technical solutions of the present disclosure.

The orientational terms, such as “up”, “down”, “left”, “right”, “front”, “rear”, “back”, “upper”, “bottom”, etc., used in the present disclosure are defined in relation to the structures shown in the accompanying drawings, which are relative concepts. Thus, it is likely that the orientational terms may be changed depending on the different positions in which they are located and the different states in which they are used. Therefore, these or other orientation terms should also not be interpreted as restrictive terms.

The present disclosure provides a sensor assembly comprising: a sensor 1, a housing 2 covering outer side of the sensor 1, and a light-shielding part 3 provided on the housing 2.

The sensor 1 according to an embodiment of the present disclosure comprises an emitting end and a receiving end. The sensor 1 can be a Time of Flight (TOF) sensor or other sensors 1 configured to detect an obstacle via an infrared light or a laser. The detecting light emitted by the emitting end can be either an infrared light or a laser. The receiving end is configured to receive the infrared light or the laser light that is reflected after the laser hits an obstacle.

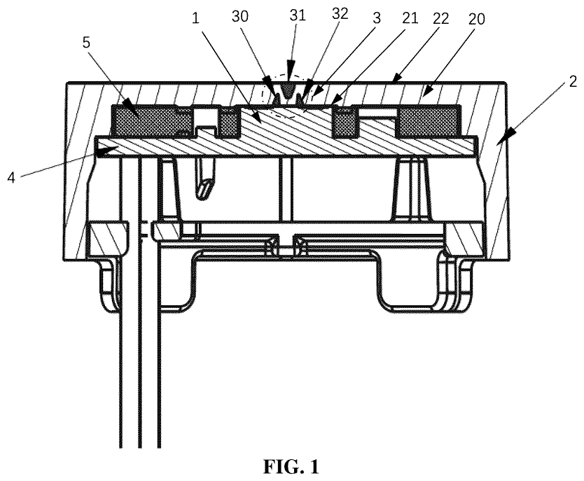

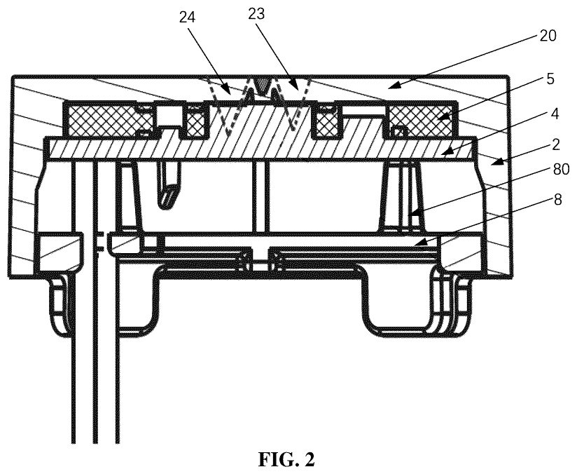

As shown in FIGS. 1 and 2, the housing 2 comprises a detecting wall 20 which comprises a light permeable emitting area 23 and a receiving area 24. The emitting area 23 is directed toward the emitting end such that the emitting end emits the detecting light toward an outer side of the housing 2. The receiving area 24 is directed toward the receiving end such that the receiving end receives the reflected light which are reflected from an outer side of the housing 2. The housing 2 according to this embodiment of the present disclosure can be made of light-permeable plastic either as a whole, or merely the emitting area 23 and the receiving area 24 are made of light-permeable plastic.

As shown in FIGS. 1 and 2, the light-shielding part 3 is located between the emitting area 23 and the receiving area 24 and comprises a first light-shielding rib 30 and a second light-shielding rib 31 having an effect of light-shielding. A first end of the first light-shielding rib 30 is located on an inner surface 21 of the detecting wall 20 (comprising the situations that the first end of the first light-shielding rib 30 is protruded from, embedded into, and aligned with the inner surface 21 of the detecting wall 20). A second end of the first light-shielding rib 30 extends into an inside the detecting wall 20. A first end of the second light-shielding rib 31 is located on an outer surface 22 of the detecting wall 20 (comprising the situations that the first end of the second light-shielding rib 31 is protruded from, embedded into, and aligned with the outer surface 22 of the detecting wall 20). A second end of the second light-shielding rib 31 extends into the inside of the detecting wall 20. The first light-shielding rib 30 and the second light-shielding rib 31 are at least partially overlapped along a thickness direction of the detecting wall 20. The thickness direction of the detecting wall 20 is in the direction from an inner surface 21 to an outer surface 22. The first light-shielding rib 30 and the second light-shielding rib 31 are at least partially overlapped in the thickness direction of the detecting wall 20, so as to effectively shield the emitting area 23 and the receiving area 24.

The first light-shielding rib 30 and the second light-shielding rib 31 according to an embodiment of the present disclosure may be made of light-impermeable plastic, metal, high polymer material, or the like, such that an effect of preventing the infrared light or the laser from passing through the first light-shielding rib 30 and the second light-shielding rib 31 is achieved. The first light-shielding rib 30 and the second light-shielding rib 31 according to this embodiment of the present disclosure may be molded on the detecting wall 20 in a manner of one-piece injection molding.

The sensor assembly according to an embodiment of the present disclosure makes the light paths between the emitting area 23 and the receiving area 24 be independent from and not interfere with each other by providing a light-shielding part 3 between the light permeable emitting area 23 and the receiving area 24. A first light-shielding rib 30 and a second light-shielding rib 31 on the light-shielding part 3 respectively extend from an inner surface 21 and an outer surface 22 of the detecting wall 20 into the internal of the detecting wall 20 and are at least partially overlapped in the thickness direction of the detecting wall 20. The sensor assembly may overcome the problem that the lights interfere with each other, which is caused by the light reflection in the housing 2. The sensor assembly may also overcome the problem that water and dust leak into the sensor 1, which is caused by the detecting wall 20 being passed through. An effect of waterproof, moisture-proof, and dust-proof is realized, and the accurate and reliable operation of the sensor are ensured.

In an embodiment, the light-shielding part 3 further comprises a third light-shielding rib 32 having an effect of light-shielding. A first end of the third light-shielding rib 32 is located on an inner surface 21 of the detecting wall 20 (comprising the situations that the first end of the third light-shielding rib 32 is protruded from, embedded into, and aligned with the inner surface 21 of the detecting wall 20). A second end of the third light-shielding rib 32 extends into the inside of the detecting wall 20. The second light-shielding rib 31 is located between the first light-shielding rib 30 and the third light-shielding rib 32. The third light-shielding rib 32 according to this embodiment of the present disclosure is also made of light-impermeable plastic, metal, high polymer material, or the like so that an effect of light-shielding is realized. The third light-shielding rib 32 is injection-molded onto the detecting wall 20 to further improve the effect of the light-shielding of the light-shielding part 3.

In an embodiment, both the first light-shielding rib 30 and the third light-shielding rib 32 are provided obliquely (e.g., tilted) toward the second light-shielding rib 31. As shown in FIGS. 1 and 2, both the first light-shielding rib 30 and the third light-shielding rib 32 are provided obliquely (e.g., tilted) toward the second light-shielding rib 31 and define an approximately triangular light-shielding area together with the second light-shielding rib 31. This may facilitate increase the emitting angle and the receiving angle of the sensor 1 and may expand the sensing range of the sensor 1.

In an embodiment, at least one of the first light-shielding rib 30, the second light-shielding rib 31, or the third light-shielding rib 32 tapers in the thickness along a direction toward the interior of the detecting wall 20. Referring to FIGS. 1 and 2, the first light-shielding rib 30, the second light-shielding rib 31, and the third light-shielding rib 32 are all in a shape of a wedge and tapered (e.g., reduced) in the thickness along the direction toward the interior of the detecting wall 20. The above structure is advantageous for improving the quality of the appearance of the detecting wall 20 and makes it possible to have the first light-shielding rib 30, the second light-shielding rib 31, and the third light-shielding rib 32 together define a triangular light-shielding area, so as to expand the sensing range of the sensor 1.

In an embodiment, the sensor assembly further comprises a circuit board 4. The sensor 1 is mounted on the circuit board 4. Referring to FIGS. 1-3, the circuit board 4 according to this embodiment of the present disclosure provides an effect of positioning the sensor 1 and controlling the actions of an executor, such as a solenoid valve 6, according to the sensing result of the sensor 1.

In an embodiment, the sensor assembly further comprises a sealing spacer 5, which is hermetically provided between the circuit board 4 and an inner surface 21 of the housing 2. Referring to FIGS. 1-3, the sealing spacer 5 in this embodiment of the present disclosure can be provided as a ring between the outer circumference of the circuit board 4 and the inner surface 21 of the housing 2, so as to effectively protect the sensor 1 located at an inner side of the circuit board 4. Moreover, when sealant is filled between the circuit board 4 and the housing 2 for fixation, the sealing spacer 5 can further prevent the sealant from overflowing into the sensor 1. The sealing spacer 5 according to this embodiment of the present disclosure can be a resilient spacer with a sealing effect, such as a foam gasket or the like.

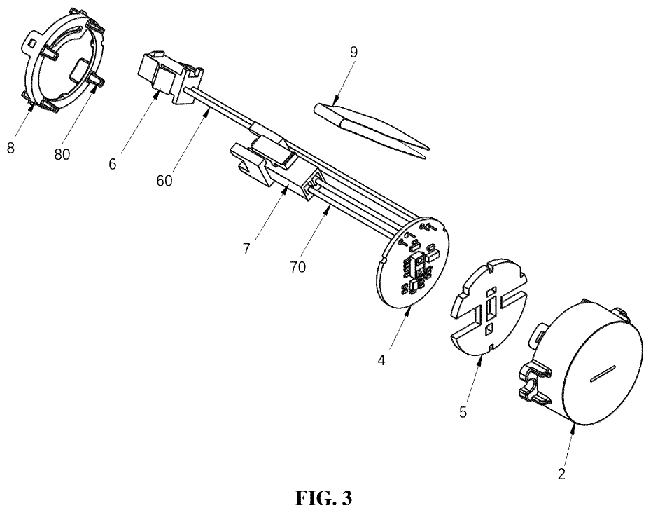

In an embodiment, the sensor assembly further comprises a solenoid valve 6. The circuit board 4 is communicably coupled to the solenoid valve 6. The circuit board 4 according to embodiment of the present disclosure controls to turn on or off the solenoid valve 6 according to a received signal sent by the sensor 1, such that the device in which the sensor assembly is located starts operating or stops operating. When the sensor 1 is applied to a faucet, the faucet is controlled to be open or closed when the solenoid valve 6 is turned on or off. As shown in FIG. 3, wires 60 may be used for connecting the circuit board 4 with the solenoid valve 6 to realize the signal transmission.

In an embodiment, the sensor assembly further comprises a power supply 7. The circuit board 4 is electrically coupled to the power supply 7. The power supply 7 according to this embodiment of the present disclosure provides a power supply for the circuit board 4, to ensure that the circuit board 4 operates stably. As shown in FIG. 3, the power supply 7 is connected to the circuit board 4 via a power cord 70.

In an embodiment, the sensor assembly further comprises a bracket 8, which is mounted on the housing 2. The bracket 8 comprises an abutting part 80, which abuts against a side of the circuit board 4, which is directed away from the sealing spacer 5. After the bracket 8 according to this embodiment of the present disclosure is mounted on the housing 2 through a snap-fit connection, the abutting part 80 abuts against the circuit board 4 to make the circuit board 4 stably squeeze the sealing spacer 5. This may ensure an effective sealing between the circuit board 4 and the inner surface 21 of the housing 2. The abutting part 80 according to this embodiment of the present disclosure may be a plurality of ribbed plate structures, which abut against the circuit board 4 along the circumferential direction of the circuit board 4.

In an embodiment, a code label 9 may be sticked to the outer side of the power cord 70 or the wires 60. Information, such as the product model, the production date, the production batch, or the like, are provided on the code label 9, so as to help the user to know the product information.

The present disclosure further provides a device comprising a sensor assembly described in any one of the above embodiments. In and embodiment, the device comprising the sensor assembly may be a faucet, a urinal, a toilet, or the like in the sanitary field or may be a robot, vehicle, a mechanical equipment of a large scale or the like in the automation field.

FIG. 4 is a block diagram of a circuit board according to an embodiment of the present disclosure. The circuit board herein may be the circuit board according to any of the embodiments, and the descriptions regarding the circuit board are incorporated herein. The circuit board is configured to perform an operation, function, or the like as described in the present disclosure.

Specifically, as described above, the sensor assembly further comprises a circuit board 4. The sensor 1 is mounted on the circuit board 4. Referring to FIGS. 1-3, the circuit board 4 according to this embodiment of the present disclosure provides an effect of positioning the sensor 1 and controlling the actions of an executor, such as a solenoid valve 6, according to the sensing result of the sensor 1.

As shown in FIG. 4, the circuit board 4 comprises a processor 410, a communication unit 420 communicably connected to the processor 410, and a storage 430 communicably connected to the processor 410.

The circuit board 4 in the present disclosure can be implemented by any appliances or by any software or applications run by the appliances. The circuit board 4 may be connected to a workstation or another external device (e.g., control panel, remote) and/or a database for receiving user inputs, system characteristics, and any of the values described herein. Optionally, the circuit board 4 may include an input device and/or a sensing circuit in communication with any of the sensors. The sensing circuit receives sensor measurements from as described above. Optionally, the circuit board 4 may include a drive unit for receiving and reading non-transitory computer media having instructions. Additional, different, or fewer components may be included.

The processor 410 is configured to perform instructions stored in memory for executing the algorithms described herein 410. The processor 410 may be a general purpose or specific purpose processor, an application specific integrated circuit (ASIC), one or more programmable logic controllers (PLCs), one or more field programmable gate arrays (FPGAs), a group of processing components, or other suitable processing components. The processor 410 is configured to execute computer code or instructions stored in memory or received from other computer readable media (e.g., embedded flash memory, local hard disk storage, local ROM, network storage, a remote server, etc.). The processor 410 may be a single device or combinations of devices, such as associated with a network, distributed processing, or cloud computing.

The communication unit 420 may include any operable connection, ingress ports, and egress ports. An operable connection may be one in which signals, physical communications, and/or logical communications may be sent and/or received. An operable connection may include a physical interface, an electrical interface, and/or a data interface. The communication unit 420 may be connected to a network. The network may include wired networks (e.g., Ethernet), wireless networks, or combinations thereof. The wireless network may be a cellular telephone network, an 802.11, 802.16, 802.20, or WiMax network, a Bluetooth pairing of devices, or a Bluetooth mesh network. Further, the network may be a public network, such as the Internet, a private network, such as an intranet, or combinations thereof, and may utilize a variety of networking protocols now available or later developed including, but not limited to TCP/IP based networking protocols.

In an embodiment, the storage 430 may include one or more devices (e.g., memory units, memory devices, storage devices, etc.) for storing data and/or computer code for completing and/or facilitating the various processes described in the present disclosure. The storage 430 may include random access memory (RAM), read-only memory (ROM), hard drive storage, temporary storage, non-volatile memory, flash memory, optical memory, or any other suitable memory for storing software objects and/or computer instructions. The storage 430 may include database components, object code components, script components, or any other type of information structure for supporting the various activities and information structures described in the present disclosure. The storage 430 may be communicably connected to processor via a processing circuit and may include computer code for executing (e.g., by processor) one or more processes described herein. For example, the storage 430 may include graphics, web pages, HTML files, XML files, script code, shower configuration files, or other resources for use in generating graphical user interfaces for display and/or for use in interpreting user interface inputs to make command, control, or communication decisions.

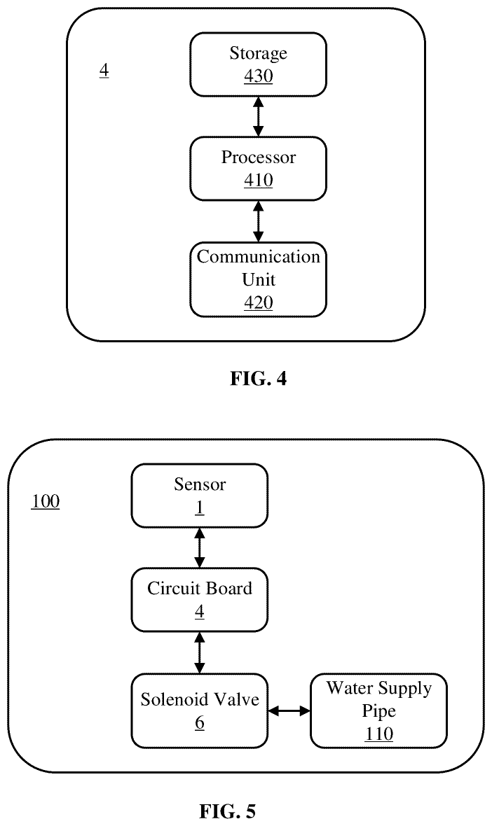

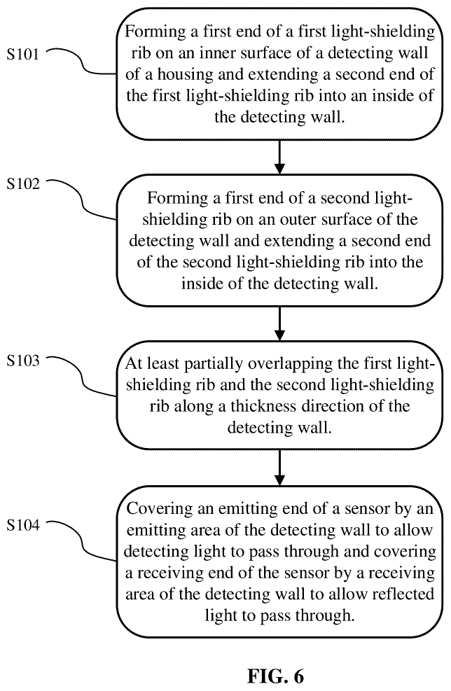

FIG. 5 is a block diagram of a device comprising a sensor assembly according to an embodiment of the present disclosure. The sensor assembly herein may be the sensor assembly according to any of the embodiments, and the descriptions regarding the sensor assembly are incorporated herein. The sensor assembly is configured to perform an operation, function, or the like as described in the present disclosure.

As shown in FIG. 5, a device 100 comprises the sensor assembly as described above and a water supply pipe 110. The sensor 1 and the solenoid valve 6 are communicably coupled to the circuit board 4. The sensor 1 is configured to detect an obstacle and generate a signal indicating whether the obstacle is detected. The sensor 1 comprises the emitting end configured to emit detecting light toward an outer side of the housing 2 through the emitting area 23. The sensor 1 comprises the receiving end configured to receive reflected light through the receiving area 24. The light-shielding part 3 is disposed between the emitting area 23 and the receiving area 24 and configured to block the detecting light and the reflected light. The circuit board 4 is configured to receive the signal from the sensor 1. The solenoid valve 6 is configured to be connected to the water supply pipe 110 and open or close the water supply pipe 110 in response to the signal. The sensor 1 is configured to generate a signal indicating that the obstacle is detected in response to the reflected light received by the receiving end.

The device 100 comprising the sensor assembly may be a faucet, a urinal, a toilet, or the like in the sanitary field or may be a robot, vehicle, a mechanical equipment of a large scale or the like in the automation field.

In an embodiment, a toilet may include a base (e.g., a pedestal, a bowl, etc.) and a tank (e.g., the hidden water tank). The base is configured to be attached to another object such as a drainpipe, floor, or another suitable object. The base includes a bowl, a sump (e.g., a receptacle) disposed below the bowl, and a trapway fluidly connecting the bowl to a drainpipe or sewage line. The tank may be supported by the base, such as an upper surface of a rim. The tank may be integrally formed with the base as a single unitary body. In other embodiments, the tank may be formed separately from the base and coupled (e.g., attached, secured, fastened, connected, etc.) to the base. The toilet may further include a tank lid covering an opening and inner cavity in the tank. The toilet may include a seat assembly including a seat and a seat cover rotatably coupled to the base. The toilet arrangement may further include a hinge assembly.

In another embodiment, the toilet arrangement may be a tankless toilet. The toilet arrangement includes a base and a seat assembly coupled to the base. The base includes a bowl, a sump disposed below the bowl, and a trapway fluidly connecting the bowl to a drainpipe or sewage line. The toilet arrangement includes a waterline that supplies the toilet with water. The toilet may further include a seat assembly including a seat and a seat cover rotatably coupled to the base. The toilets described above are provided herein as non-limiting examples of toilets that may be configured to utilize aspects of the present disclosure.

In some examples, a bidet may be included in a seat or pedestal of a toilet. In other examples, the bidet may be manufactured separately from and attached or coupled to a seat or pedestal of a toilet. The bidet includes a housing. The housing is configured to receive a flow of water through a housing inlet and dispense the flow of water from a housing outlet. The housing inlet and housing outlet may be located on opposite ends of the housing from one another, such that water may flow through the housing from the housing inlet to the housing outlet. In some examples, the housing further includes a chamber. As the housing receives the flow of water, the chamber may fill with water and provide a flow of water between the housing inlet and the housing outlet. The chamber may be configured to contain the flow of water and direct the flow of water from the housing inlet to the housing outlet. After the chamber has filled with water, the flow of water may travel along a substantially linear path between the housing inlet and the housing outlet. In some examples, one or more walls within the housing may be included to help direct a flow of water between the housing inlet and the housing outlet. The bidet may further include a housing inlet conduit configured to direct a flow of water to the housing inlet. The housing inlet conduit may be coupled to a water supply such as tank or waterline. The housing may further include a gear assembly or a portion of the gear assembly. The bidet may be a front wash bidet for female users and may use, generate, and/perform the functions related to nanobubbles, ozonated water, eWater, hydrogen peroxide generation, pH Control, template assisted crystallization, application of polyphosphates, filtration (ultrafiltration, nanofiltration, microfiltration, carbon/GAC), fluidic oscillating sprays, and adding other consumables in the water stream. For nanobubbles, air, ozone, oxygen, hydrogen, and carbon dioxide may be used.

An embodiment of the present disclosure further provides a method for manufacturing a sensor assembly. FIG. 6 is a flow chart of a method for manufacturing a sensor assembly according to an embodiment of the present disclosure. The sensor assembly in the method may be the sensor assembly according to any of the embodiments, and the descriptions regarding the sensor assembly are incorporated herein. The sensor assembly is configured to perform an operation, function, or the like as described in the present disclosure.

At act S101, the first end of the first light-shielding rib 30 is formed on the inner surface of the detecting wall 20 of the housing 2 and the second end of the first light-shielding rib 30 is extended into the inside of the detecting wall 20.

Specifically, as described above, a first end of the first light-shielding rib 30 is located on an inner surface 21 of the detecting wall 20 (comprising the situations that the first end of the first light-shielding rib 30 is protruded from, embedded into, and aligned with the inner surface 21 of the detecting wall 20). A second end of the first light-shielding rib 30 extends into an inside the detecting wall 20.

At act S102, the first end of the second light-shielding rib 31 is formed on the outer surface of the detecting wall 20, and the second end of the second light-shielding rib 31 is extended into the inside of the detecting wall 20.

Specifically, as described above, a first end of the second light-shielding rib 31 is located on an outer surface 22 of the detecting wall 20 (comprising the situations that the first end of the second light-shielding rib 31 is protruded from, embedded into, and aligned with the outer surface 22 of the detecting wall 20). A second end of the second light-shielding rib 31 extends into the inside of the detecting wall 20.

At act S103, the first light-shielding rib 30 and the second light-shielding rib 31 are at least partially overlapped along the thickness direction of the detecting wall 20.

Specifically, as described above, the first light-shielding rib 30 and the second light-shielding rib 31 are at least partially overlapped in the thickness direction of the detecting wall 20, so as to effectively shield the emitting area 23 and the receiving area 24.

The first light-shielding rib 30 and the second light-shielding rib 31 according to an embodiment of the present disclosure may be made of light-impermeable plastic, metal, high polymer material, or the like, such that an effect of preventing the infrared light or the laser from passing through the first light-shielding rib 30 and the second light-shielding rib 31 is achieved. The first light-shielding rib 30 and the second light-shielding rib 31 according to this embodiment of the present disclosure may be molded on the detecting wall 20 in a manner of one-piece injection molding.

At act S104, the emitting end of the sensor 1 is covered by the emitting area 23 of the detecting wall 20 to allow the detecting light to pass through, and the receiving end of the sensor is covered by the receiving area 24 of the detecting wall 20 to allow the reflected light to pass through.

Specifically, as described above, as shown in FIGS. 1 and 2, the housing 2 comprises a detecting wall 20 which comprises a light permeable emitting area 23 and a receiving area 24. The emitting area 23 is directed toward the emitting end such that the emitting end emits the detecting light toward an outer side of the housing 2. The receiving area 24 is directed toward the receiving end such that the receiving end receives the reflected light which are reflected from an outer side of the housing 2. The housing 2 according to this embodiment of the present disclosure can be made of light-permeable plastic either as a whole, or merely the emitting area 23 and the receiving area 24 are made of light-permeable plastic.

As shown in FIGS. 1 and 2, the light-shielding part 3 is located between the emitting area 23 and the receiving area 24 and comprises a first light-shielding rib 30 and a second light-shielding rib 31 having an effect of light-shielding.

The above technical solutions may be combined as required to achieve the best technical effect.

The above are merely the principle and the embodiments of the present disclosure. It should be pointed out that, for those having ordinary skill in the art, other variations may be made based on the principle of the present disclosure, which should also be regarded as falling into the protection scope of the present disclosure.

1-10. (canceled)

11. A sensor assembly, comprising:
a sensor;
a housing comprising a detecting wall configured to cover the sensor; and
a light-shielding part comprising:
a first light-shielding rib having a first end disposed on an inner surface of the detecting wall and a second end extending into an inside of the detecting wall; and
a second light-shielding rib having a first end disposed on an outer surface of the detecting wall and a second end extending into the inside of the detecting wall,
wherein the first light-shielding rib and the second light-shielding rib are at least partially overlapped along a thickness direction of the detecting wall.

12. The sensor assembly according to claim 11, wherein the sensor comprises:
an emitting end configured to emit detecting light toward an outer side of the housing; and
a receiving end configured to receive reflected light,
wherein the detecting wall comprises:
an emitting area directed toward the emitting end; and
a receiving area directed toward the receiving end, and
wherein the light-shielding part is disposed between the emitting area and the receiving area.

13. The sensor assembly according to claim 12, wherein the light-shielding part further comprises a third light-shielding rib comprising a first end disposed on an inner surface of the detecting wall and a second end extending into the inside of the detecting wall, and
wherein the second light-shielding rib is disposed between the first light-shielding rib and the third light-shielding rib.

14. The sensor assembly according to claim 13, wherein the first light-shielding rib and the third light-shielding rib are titled toward the second light-shielding rib.

15. The sensor assembly according to claim 13, wherein at least one of the first light-shielding rib, the second light-shielding rib, or the third light-shielding rib has a reduced thickness along a direction toward the inside of the detecting wall.

16. The sensor assembly according to claim 13, wherein the emitting area and the receiving area are light permeable, and
wherein the first light-shielding rib, the second light-shielding rib, and the third light-shielding rib are light impermeable.

17. The sensor assembly according to claim 11, further comprising: a circuit board configured to install the sensor.

18. The sensor assembly according to claim 17, further comprising a sealing spacer disposed between the circuit board and an inner surface of the housing.

19. The sensor assembly according to claim 17, further comprising a solenoid valve communicably coupled to the circuit board.

20. The sensor assembly according to claim 18, further comprising a bracket configured to be mounted on the housing, and
wherein the bracket comprises an abutting part configured to abut against a side, directed away from the sealing spacer, of the circuit board.

21. The sensor assembly according to claim 11, wherein the light-shielding part is formed integrally with the detecting wall.

22. A device for supplying water, the device comprising:
a water supply pipe;
a housing comprising an emitting area and a receiving area;
a sensor configured to detect an obstacle and generate a signal indicating whether the obstacle is detected, the sensor comprising:
an emitting end configured to emit detecting light toward an outer side of the housing through the emitting area; and
a receiving end configured to receive reflected light through the receiving area,
a light-shielding part disposed between the emitting area and the receiving area and configured to block the detecting light and the reflected light;
a circuit board communicably coupled to the sensor and configured to receive the signal from the sensor; and
a solenoid valve communicably coupled to the circuit board and configured to be connected to the water supply pipe and open or close the water supply pipe in response to the signal,
wherein the sensor is configured to generate a signal indicating that the obstacle is detected in response to the reflected light received by the receiving end.

23. The device according to claim 22, further comprising:
a housing comprising a detecting wall configured to cover the sensor; and
a light-shielding part comprising:
a first light-shielding rib having a first end disposed on an inner surface of the detecting wall and a second end extending into an inside of the detecting wall;
a second light-shielding rib having a first end disposed on an outer surface of the detecting wall and a second end extending into the inside of the detecting wall,
wherein the first light-shielding rib and the second light-shielding rib are at least partially overlapped along a thickness direction of the detecting wall,
wherein the detecting wall comprises:
an emitting area directed toward the emitting end; and
a receiving area directed toward the receiving end.

24. The device according to claim 23, wherein the light-shielding part further comprises a third light-shielding rib comprising a first end disposed on an inner surface of the detecting wall and a second end extending into the inside of the detecting wall, and
wherein the second light-shielding rib is disposed between the first light-shielding rib and the third light-shielding rib.

25. The device according to claim 24, wherein the device is a faucet, a urinal, or a toilet.

26. A method for manufacturing a sensor assembly, the method comprising:
forming a first end of a first light-shielding rib on an inner surface of a detecting wall of a housing and extending a second end of the first light-shielding rib into an inside of the detecting wall;
forming a first end of a second light-shielding rib on an outer surface of the detecting wall and extending a second end of the second light-shielding rib into the inside of the detecting wall;
at least partially overlapping the first light-shielding rib and the second light-shielding rib along a thickness direction of the detecting wall; and
covering an emitting end of a sensor by an emitting area of the detecting wall to allow detecting light to pass through and covering a receiving end of the sensor by a receiving area of the detecting wall to allow reflected light to pass through.

27. The method according to claim 26, further comprising:
forming the first light-shielding rib and the second light-shielding rib between the emitting area and the receiving area.

28. The method according to claim 27, further comprising:
forming a first end of a third light-shielding rib on an inner surface of the detecting wall and extending a second end of the third light-shielding rib into the inside of the detecting wall, and
forming the third light-shielding rib between the emitting area and the receiving area; and
forming the second light-shielding rib between the first light-shielding rib and the third light-shielding rib.

29. The method according to claim 26, further comprising:
communicably coupling the sensor to a circuit board; and
communicably coupling a solenoid valve to the circuit board.

30. The method according to claim 29, further comprising:
installing a sealing spacer disposed between the circuit board and an inner surface of the housing; and
abutting an abutting part of a bracket against a side, directed away from the sealing spacer, of the circuit board.
